(19) United States
(12) Patent Application Publication
(10) Pub. No.: US 2008/0180602 A1
(43) Pub. Date: Jul. 31, 2008

(54) SEMI-TRANSMISSIVE LIQUID CRYSTAL DISPLAY DEVICE

(76) Inventor: Tatsuo Hamamoto, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/028,040

(22) Filed: Feb. 8, 2008

(30) Foreign Application Priority Data
Sep. 8, 2006 (JP) 2006-244742

(51) Int. Cl. G02F 1/1335

(52) U.S. Cl. 349/95

(57) ABSTRACT

According to the invention, a semi-transmissive liquid crystal display device that achieves good brightness in both reflection mode and transmission mode is provided. In the invention, two cylindrical microlenses are formed at the backlight side of the TFT substrate dividing the area of the pixel into two, and further, another cylindrical microlens is formed which covers the whole pixel at the external light incident surface of the CF substrate.

### CROSS-REFERENCE TO RELATED APPLICATIONS

The disclosure of Japanese Patent Application No. 2006-244742 filed on Sep. 8, 2006 including the specification, drawings and abstract is incorporated herein by reference in its entirety.

### BACKGROUND

1. Field of the invention

The present invention relates to a semi-transmissive liquid crystal display device having a reflection mode and a transmission mode.

### DESCRIPTION OF RELATED ARTS

A semi-transmissive liquid crystal display device is incapable of a bright display comparable to all-reflective or all-transmissive types because its pixel part is divided into a reflection section and a transmission section; however, it has advantages of the all-reflective and all-transmissive types. Especially, when the external light is strong, a display with good visibility can be obtained only by the reflection mode, with the back light turned off for power saving.

FIG. 6 is a sectional view of a pixel part of a conventional semi-transmissive liquid crystal display device. In FIG. 6, plural signal lines 62 and plural scan lines (not shown) are wired on a thin-film transistor substrate (TFT substrate) 61, and thin-film transistors (TFTs) (not shown) are provided at intersections of the scan lines and signal lines. Further, a reflecting plate 63 is provided in an external light reflection area ELA.

Black matrices 65 and a color filter 66 are formed on the face of a color filter substrate (CF substrate) 64 facing the TFT substrate 61. The color filter 66 is a blue (B) filter, for example, and a red (R) filter is provided on the left and a green (G) filter is provided on the right thereof. The R, G, B filters are covered by a protective film 67 and a gap adjustment layer 68 is formed in the external light reflection area ELA on the protective film 67. Further, a diffusion layer 69 is provided on the other face of the TFT substrate 61 opposite from the CF substrate 64.

The TFT substrate 61 and the CF substrate 64 are provided facing each other via photo-spacers 70 formed on the signal lines 62, maintaining a clearance for a liquid crystal layer 71.

Dotted arrows in FIG. 6 indicate backlight from a backlight (not shown). The backlight transmits through backlight transmission areas BLA and is diffused in the diffusion layer 69. Further, solid arrows in FIG. 6 indicate external light and the light is reflected by the reflecting plate 63 and diffused in the diffusion layer 69. In this way, although the diffusion layer 69 is provided for diffusing the external light reflected by the reflecting plate 63, the layer also diffuses the backlight.

Here, regarding a microlens in the invention, Japanese Patent Laid-open Hei 11-248905 (Ref. 1) discloses a method of manufacturing a planar microlens array by ion exchange, used for improving the light use efficiency of a liquid crystal panel. Further, Japanese Patent Laid-open No. 2002-148411 (Ref. 2) discloses a method of manufacturing a planar microlens by ion implantation. Furthermore, Japanese Patent Laid-open No. 2005-67933 (Ref.3) discloses a method of manufacturing a microlens by laser radiation, applicable to a liquid crystal display.

### SUMMARY

In the semi-transmissive liquid crystal display device, the aperture ratio of the transmission section is restricted by the wiring of substrate and black matrices of color filters, but it is principally lowered by the reflecting plate provided in the reflection section. Further, in the conventional case where the diffusion layer is externally provided to allow viewing of the reflection light reflected from the reflection section over a wide angle range, the transmission light transmitted from the transmission section is also diffused and the front luminance and contrast become lower.

A purpose of the invention is to achieve brightness in both reflection mode and transmission mode.

The reflection section is provided at the center of a pixel (also referred to as a subpixel for colors) and a microlens covering the entire pixel is formed on the color filter substrate at the viewing side. The incident light (external light) incident to the entire pixel area is collected to the reflection section at the pixel center, and thereby, the brightness in the reflection mode is made higher, and simultaneously, a reflection image is visible in a wider range because the reflection light refracted by the microlens is output at wider angles than that of the incident light.

On the backlight side of the thin-film transistor substrate at, microlenses having a shorter focal length than that of the microlens on the color filter substrate are provided at positions corresponding to the transmission sections divided into two by the reflection section. The light which was blocked by the reflection section in the conventional device is collected to the transmission sections by the microlens, and thereby, the effective aperture ratio is made larger. Simultaneously, the front luminance is kept higher by the microlens on the color filter substrate which makes the light parallel again.

As described above, according to the invention, in a location where natural light such as sunlight is strong, the natural light is collected by the microlens and reflected by the reflection section, and thereby, the brightness of the display device can be improved. Further, in a location where there is no natural light or artificial light such as illumination, the backlight is collected by the microlenses and transmitted through the transmission sections, and thereby, the brightness of the display device can be improved. Furthermore, in a location where external light such as natural light or artificial light is weak, the external light and the backlight are collected by the microlens and entered into the reflection section and the transmission section respectively, and thereby, the brightness of the display device can be improved by using both the reflection mode and the transmission mode.

### BRIEF DESCRIPTION OF THE DRAWINGS

FIG. 1 is a sectional view of a pixel part of a semi-transmissive liquid crystal display device according to the invention.

FIGS. 2A and 2B are explanatory diagrams of diffusion effects of a reflection section.

FIGS. 3A and 3B are explanatory diagrams for reducing the diffusion effect of a transmission section.

FIG. 4 is a perspective view of lenses provided for a pixel.

FIG. 5 is a plan view of a pixel in the case of color display.

FIG. 6 is a sectional view of a pixel part of a conventional semi-transmissive liquid crystal display device.

### DETAILED DESCRIPTION OF THE INVENTION

Hereinafter, an embodiment of the invention will be described using the drawings.

### Embodiment 1

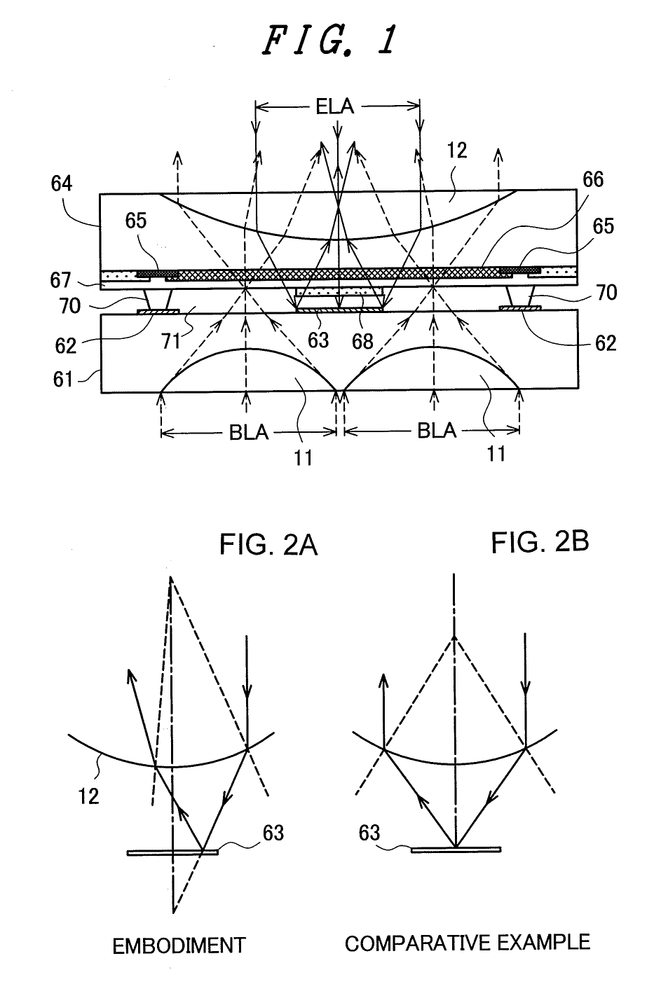

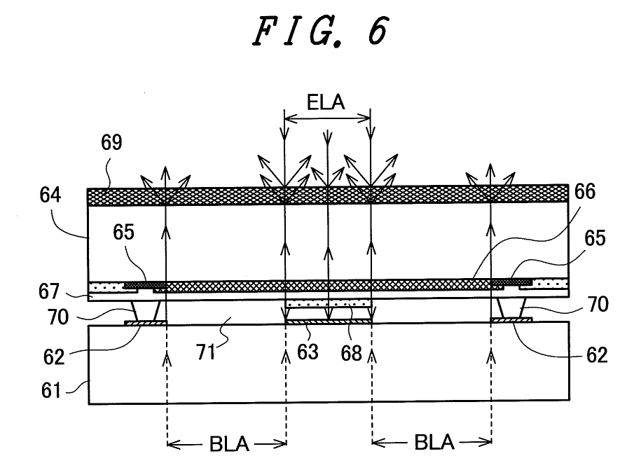

FIG. 1 is a sectional view of a pixel part of a semi-transmissive liquid crystal display device according to the invention. The device in FIG. 1 is different from the conventional device in FIG. 6 in that the diffusion layer 69 in FIG. 6 is omitted and cylindrical microlenses 11 are formed so as to divide a pixel into two at the backlight side of the TFT substrate 61, and further, a cylindrical microlens 12 is formed to cover the pixel at the external light incident surface of the CF substrate 64. The other configuration is the same as has been described regarding FIG. 6, and the description herein is omitted.

Since the microlenses 11, 12 are thus provided, the external light reflection area ELA and the backlight transmission areas BLAs are made larger than those shown in FIG. 6, and thereby, the brightness of the display device is improved. The focal length of the microlenses 11 is made shorter than the focal length of the microlens 12.

Further, in the case where the glass composition suitable for forming the microlens and the glass composition suitable for forming the TFT substrate and the CF substrate are not necessarily the same, glass substrates on which microlenses have been formed separately may be bonded on the TFT substrate and the CF substrate to form a multilayered structure.

The manufacture of a planar microlens array may be performed according to known methods such as ion exchange by immersion in molten salt, ion implantation, or femto second laser radiation, but among these ion implantation that enables manufacture of high-definition lens arrays, and changing the refractive index by laser radiation are preferable.

FIGS. 2A and 2B are explanatory diagrams of diffusion effects of a reflection section shown in FIG. 1; FIG. 2A shows the present embodiment and FIG. 2B shows a comparative example. In FIG. 2B, a lens with the focal point at the reflecting plate 63 is provided as the comparative example. Here, the external light (parallel light) is reflected and output as parallel light, and therefore, the location where the reflection image is viewable is restricted. However, when the focal point is beyond the reflecting plate as in the present embodiment, the output light is not parallel light (the image is blurry), and thereby, the reflection image is visible in a wider angle range.

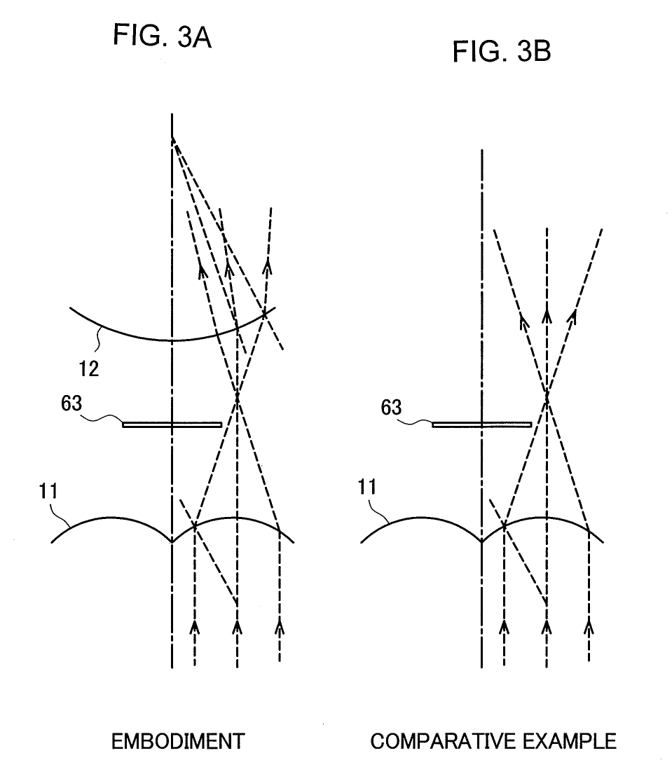

FIGS. 3A and 3B are explanatory diagrams for reducing the diffusion effect of a transmission section shown in FIG. 1. FIG. 3A shows the present embodiment and FIG. 3B shows a comparative example. In FIGS. 3A and 3B, when the lens 11 is provided only on the TFT substrate for collecting the light from the backlight to the transmission section as in the comparative example, the output light is diffused (image blur) and the front brightness and the contrast become lower. However, in the present embodiment, because the lens 12 of the CF substrate also serves to collect light to the reflection section, the output light of backlight is not completely but nearly parallel light.

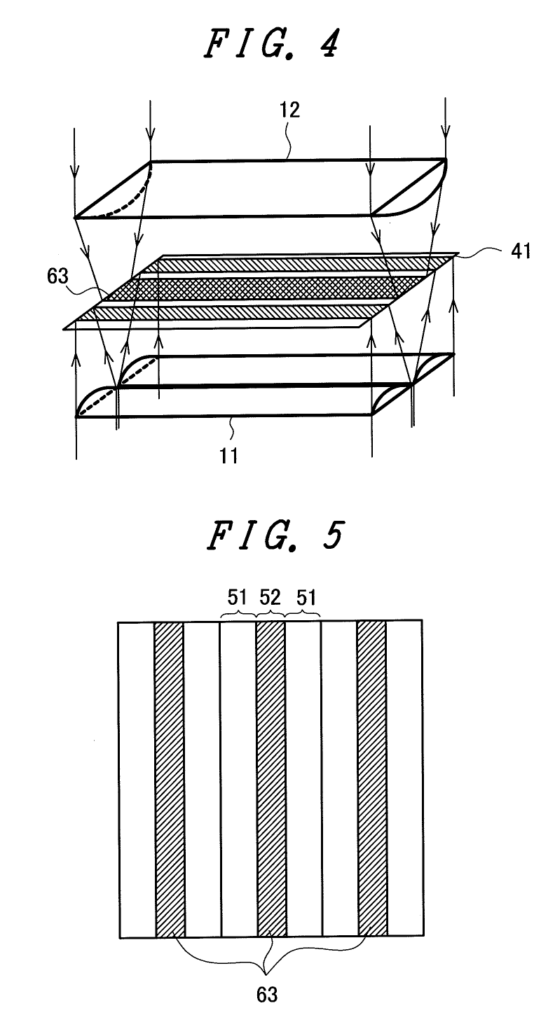

FIG. 4 is a perspective view of lenses provided in a pixel. In FIG. 4, the reflecting plate 63 is provided at the center along the longitudinal direction of a pixel 41, and the cylindrical lenses 11 are provided at positions corresponding to the respective transmission sections on both sides of the pixel 41 so as to cover the transmission sections. Further, the cylindrical lens 12 is provided at a position corresponding to the reflection section to cover the pixel 41.

FIG. 5 is a plan view of a pixel in the case of color display, the pixel comprising three subpixels. In FIG. 5, a reflecting plate 63 is provided in each subpixel, so that each subpixel is divided into three sections, two transmission sections 51 and one reflection section 52.

1. A semi-transmissive liquid crystal display device comprising both a reflection section and a transmission section,
the reflection section being located at a center of a pixel,
a microlens covering the pixel being formed on a color filter substrate, and
a microlens being formed on a thin-film transistor substrate so as to cover the transmission section.

2. The semi-transmissive liquid crystal display device according claim 1, wherein there are two transmission sections located on both sides of the pixel, and
the focal length of the microlenses covering the transmission sections is shorter than the focal length of the microlens covering the whole pixel.

3. A liquid crystal display device comprising a liquid crystal panel formed by sandwiching liquid crystal between two transparent substrates and a backlight unit on the rear side of the liquid crystal panel,
the liquid crystal panel configured to have a display area formed of plural pixels,
each pixel of the plural pixels having a reflection section and a transmission section, and
the reflection section being sandwiched by said transmission section.

4. The liquid crystal display device according to claim 3, wherein a color filter is provided on one of the two transparent substrates, plural first microlenses one covering each of the pixels are formed on that transparent substrate, and plural second microlenses covering the transparent section is formed on the other of the two transparent substrates.
